(19) United States
(12) Patent Application Publication
(10) Pub. No.: US 2024/0242136 A1
(43) Pub. Date: Jul. 18, 2024

(54) Data Substitution System and Data Substitution Method

(71) Applicant: Hitachi, Ltd., Chiyoda-ku, Tokyo (JP)

(72) Inventors: Hidenori YAMAMOTO, Tokyo (JP); Hirotaka MORIBE, Tokyo (JP); Shinya SUENAGA, Tokyo (JP)

(21) Appl. No.: 18/562,504

(22) PCT Filed: Jun. 9, 2022
(86) PCT No.: PCT/JP2022/023289

§ 371 Date: Nov. 20, 2023

(30) Foreign Application Priority Data
Jul. 1, 2021 (JP) 2021-110407

(51) Int. Cl. G06Q 10/04; G06Q 50/06

(52) U.S. Cl. CPC G06Q 10/04; G06Q 50/06

(57) ABSTRACT

A data substitution system includes: a communication unit configured to receive data related to power transfer from a consumer server provided in each of a plurality of consumers; a group formation processing unit configured to select, when a predetermined facility related to the power transfer is included in profile information of a consumer included in the received data related to the power transfer, the consumer as a representative consumer, select, as a member consumer, a consumer in which a degree of coincidence with the profile information of the selected representative consumer and with behavior information which is related to power supply and demand of the representative consumer and which is associated with the data related to the power transfer is equal to or higher than a predetermined threshold, and form the selected representative consumer and member consumer as one group; a prediction substitution processing unit configured to predict a situation related to the power supply and demand using a predetermined prediction algorithm for the selected representative consumer in the formed group and set a result of the prediction as a prediction result for the member consumer; and a data substitution processing unit configured to substitute the result of the prediction as a prediction result for a member consumer included in the group.

### TECHNICAL FIELD

The present invention relates to a data substitution system and a data substitution method.

### BACKGROUND ART

There are various techniques for monitoring related to power transaction and power transfer, data analysis processing, and the like in the related art. For example, PTL 1 proposes a collection device including a collection unit that collects power data of a controlled device, an interpolation unit that interpolates, when there is a defective portion in the power data collected by the collection unit, the defective portion, and an output unit that outputs interpolated power data that is the power data interpolated by the interpolation unit.

### CITATION LIST

### Patent Literature

PTL 1: JP2019-176544A

### SUMMARY OF INVENTION

### Technical Problem

In a case of performing power transaction and power transfer for a large number of small scale consumers and monitoring and adjusting consumers to complete a contract of the power transaction, in order to complete the monitoring and the adjustment until a power transfer execution time without delay, it is required to reduce a load of processing related to situation understanding and prediction to be individually executed for the large number of target consumers. In addition, it is also required to reduce a load of processing for collecting data necessary for actual evaluation of the consumers and the like from the large number of consumers having different data.

In the technique disclosed in PTL 1, it is necessary to execute the processing related to the situation understanding and prediction of each consumer using data for each of the target consumers, and as the number of target consumers increases, the load of the processing related to the situation understanding and prediction increases. In addition, only data that can be acquired at the portion can be interpolated, and data cannot be acquired if the data type corresponding to a service request is not present at the portion.

An object of the invention is to provide a data substitution system and a data substitution method capable of acquiring data, for which a service is requested, without increasing a load of processing related to situation understanding and prediction accompanying an increase in the number of target consumers.

### Solution to Problem

A data substitution system according to the invention is a data substitution system in a power service system for transmitting and receiving, by a computer, data related to power transfer with a plurality of consumers in a preliminary phase in which a power supply and demand situation is monitored to perform power supply and demand prediction for the power transfer with the plurality of consumers and in a post phase in which a consumed power supply and demand record is monitored based on the power transfer. The data substitution system includes: a communication unit configured to receive the data related to the power transfer from a consumer server provided in each of the plurality of consumers; a group formation processing unit configured to select, when a predetermined facility related to the power transfer is included in profile information of a consumer included in the received data related to the power transfer, the consumer as a representative consumer, select, as a member consumer, a consumer in which a degree of coincidence with the profile information of the selected representative consumer and with behavior information which is related to power supply and demand of the representative consumer and which is associated with the data related to the power transfer is equal to or higher than a predetermined threshold, and form the selected representative consumer and member consumer as one group; a prediction substitution processing unit configured to predict a situation related to the power supply and demand using a predetermined prediction algorithm for the selected representative consumer in the formed group and set a result of the prediction as a prediction result for the member consumer; and a data substitution processing unit configured to substitute the result of the prediction as a prediction result for a member consumer included in the group, the units being executed by the computer.

### Advantageous Effects of Invention

According to the invention, it is possible to acquire data, for which a service is requested, without increasing a load of processing related to situation understanding and prediction accompanying an increase in the number of target consumers.

### BRIEF DESCRIPTION OF DRAWINGS

FIG. 1 is a diagram showing an example of a system configuration to which a data substitution system according to an embodiment is applied.

FIG. 2 is a diagram showing an example of executing power transaction, contract monitoring, and power transfer when the present embodiment is applied.

FIG. 3 is a diagram showing a module configuration of an energy platform server and a consumer server according to the present embodiment.

FIG. 4A is a diagram showing a configuration of a table used in the data substitution system according to the present embodiment (consumer group information table).

FIG. 4B is a diagram showing a configuration of a table used in the data substitution system according to the present embodiment (consumer information table).

FIG. 5 is a flowchart showing a flow of processing for executing formation of a consumer group, prediction substitution, and data substitution based on a degree of coincidence in a consumer profile and a behavior in the data substitution system according to the present embodiment.

FIG. 6 is a flowchart showing a flow of processing for calculating the degree of coincidence in the consumer profile and the behavior and forming the consumer group in the data substitution system according to the present embodiment.

FIG. 7 is a diagram showing a concept for selecting a more similar consumer in the data substitution system according to the present embodiment.

FIG. 8 is a flowchart showing a flow of processing for executing the prediction substitution in the formed consumer group in the data substitution system according to the present embodiment.

FIG. 9 is a flowchart showing a flow of processing for executing the data substitution in the formed consumer group and calculating a degree of accuracy of the substitution data in the data substitution system according to the present embodiment.

FIG. 10 is a diagram showing an image of a screen for presenting, to a user, the substitution data provided in a system to which the data substitution system according to the present embodiment is applied.

### DESCRIPTION OF EMBODIMENTS

Hereinafter, embodiments of the invention will be described with reference to the drawings. The following description and drawings are examples for showing the invention, and are appropriately omitted and simplified for clarity of the description. The invention can be implemented in various other forms. Unless otherwise specified, each component may be single or plural.

In order to facilitate understanding of the invention, the position, size, shape, range, and the like of each component shown in the drawings may not represent the actual position, size, shape, range, and the like. Therefore, the invention is not necessarily limited to the positions, sizes, shapes, ranges, and the like disclosed in the drawings.

In the following description, various types of information may be described by expressions such as “database”, “table”, and “list”, but various types of information may be expressed by other data structures. In order to indicate that the information does not depend on the data structure, “XX table”, “XX list”, and the like may be referred to as “XX information”. In description of identification information, when expressions such as “identification information”, “identifier”, “name”, “ID”, and “number” are used, the expressions can be replaced with each other.

When there are a plurality of components having the same or similar functions, the same reference numerals may be assigned with different subscripts. However, when it is not necessary to distinguish the plurality of components, the description may be made by omitting the subscripts.

In addition, in the following description, processing performed by executing a program may be described, and the program is executed by a processor (for example, a central processing unit (CPU) or a graphics processing unit (GPU)), so that predetermined processing is performed using a storage resource (for example, a memory) and/or an interface device (for example, a communication port) as appropriate. Therefore, a subject of the processing may be the processor. Similarly, the subject of the processing performed by executing the program may be a controller, a device, a system, a computer, or a node including a processor. The subject of the processing performed by executing the program may be an arithmetic unit, and may include a dedicated circuit (for example, a field-programmable gate array (FPGA) or an application specific integrated circuit (ASIC)) that performs specific processing.

The program may be installed on a device such as a computer from a program source. The program source may be, for example, a program distribution server or a computer-readable storage medium. When the program source is a program distribution server, the program distribution server may include a processor and a storage resource for storing a program to be distributed, and the processor of the program distribution server may distribute the program to be distributed to another computer. In addition, in the following description, two or more programs may be implemented as one program, or one program may be implemented as two or more programs.

### Embodiment 1

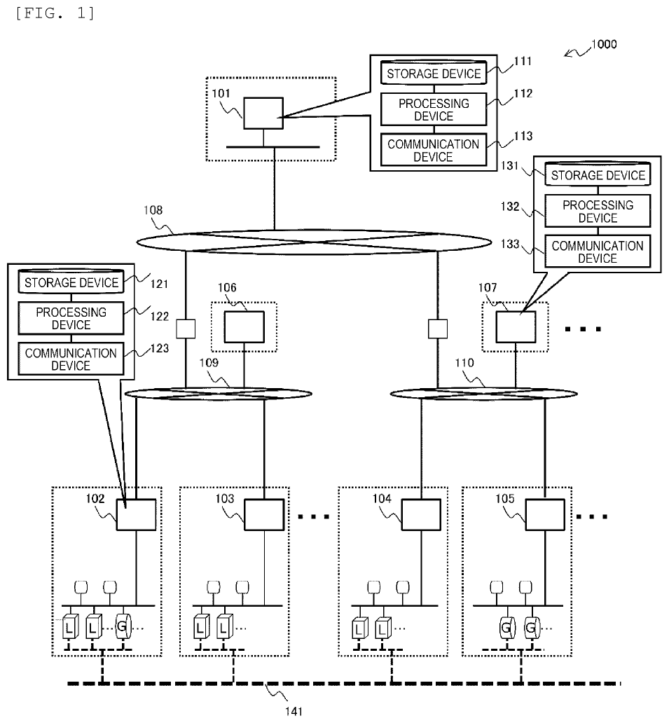

FIG. 1 is a diagram showing an example of a configuration of a power service system 1000 to which a data substitution system according to an embodiment is applied.

Main components of the power service system 1000 include: an energy platform server 101 including a data substitution system that manages consumers and performs processing related to power market transaction of small scale consumers and processing related to understanding and prediction of a situation related to power supply and demand of the consumers for contract monitoring; consumer servers (102, 103, 104, 105) on each of which a home energy management system (HEMS) such as a smart meter or an internet of things (IOT) sensor that manages consumer data or manages consumer facilities is operated in each consumer; and area energy management system (AEMS) servers (106, 107) that are disposed in respective areas and each of which performs power transfer in the corresponding area and management of the consumers.

The energy platform server 101 and the consumer servers (102, 103, 104, 105) are interconnected via a network 108 and networks (109, 110). The consumer servers (102, 103, 104, 105) and the AEMS servers (106, 107) are interconnected via the networks (109, 110). However, the provision of data from the consumer servers (102, 103, 104, 105) to the energy platform server 101 may be performed not only by communication via the network 108 and the networks (109, 110), but also by data storage into the energy platform server 101, for example, manually, not via the network 108 and the networks (109, 110). The consumer facilities in each consumer receive power from a power system 141.

A main hardware configuration of the energy platform server 101 includes a storage device (memory, hard disk) 111, a processing device (CPU) 112, and a communication device 113. A main hardware configuration of each of the consumer servers (102, 103, 104, 105) includes a storage device (memory, hard disk) 121, a processing device (CPU) 122, and a communication device 123. A main hardware configuration of each of the AEMS servers (106, 107) includes a storage device (memory, hard disk) 131, a processing device (CPU) 132, and a communication device 133.

Various types of data stored in each server or device or used for processing can be implemented by the CPU reading the data from the memory or the hard disk and using the data. In addition, each functional unit of each server or device can be implemented by the CPU loading a predetermined program stored in the hard disk into the memory and executing the program.

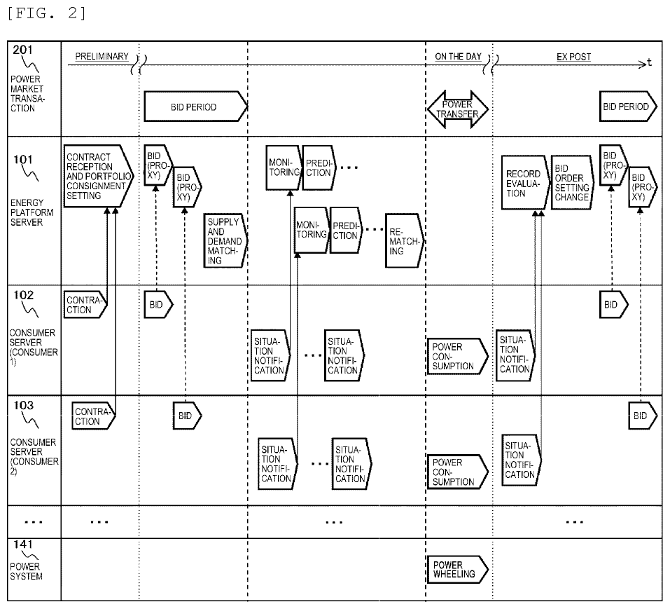

FIG. 2 is a diagram showing an example of executing power transaction, contract monitoring, and power transfer in the power service system 1000 to which the data substitution system according to the present embodiment is applied.

The main components include the energy platform server 101 that performs processing related to a power market transaction 201 of small scale consumers and processing related to understanding and prediction of a situation related to power supply and demand of the consumers for contract monitoring, the consumer servers (102, 103) provided in a consumer 1 and a consumer 2 that perform power transaction and power transfer based on a contract, and the power system 141 that performs power wheeling for the above.

In a preliminary phase, the consumer servers (102, 103) of the consumer 1 and the consumer 2 execute contract processing based on a contract made between the consumers 1 and 2 and a business operator operating an energy platform, and the energy platform server 101 performs a portfolio consignment setting related to the power transaction. In a bid period, based on the portfolio of the consumer servers (102, 103) of the consumer 1 and the consumer 2, the energy platform server 101 executes proxy processing of bidding on behalf of the consumer servers (102, 103) of the consumer 1 and the consumer 2, executes supply and demand matching for adjusting the demand and the supply by the bid, and makes a contract of the power transaction.

After the bidding is ended and the contract is made, the energy platform server 101 executes the contract monitoring on whether the power can be transferred according to the contract, until a power transfer time is reached. That is, situation notification related to the power supply and demand from the consumer servers (102, 103) of the consumers 1 and 2 is periodically received, a current situation is understood, and a situation related to the power supply and demand of the consumers at the power transfer time is predicted. When it is determined from the result that the contract is difficult to achieve, the energy platform server 101 re-executes the supply and demand matching.

After the supply and demand matching is re-executed, when the power transfer time of the current day is reached, the power is delivered by the power system 141, and the power is consumed by the consumer 1 and the consumer 2 holding the consumer servers (102, 103).

In addition, in a post phase, the energy platform server 101 executes evaluation on a record of the power transaction of the consumers by using the data related to the situation related to the power supply and demand of the consumers acquired from the consumer servers (102, 103) of the consumer 1 and the consumer 2. Based on the evaluation result, the energy platform server 101 performs a bid order setting change and the like by the consumer servers (102, 103) of the consumer 1 and the consumer 2 in order to make the contract more appropriate, and continues a bid for the subsequent transaction.

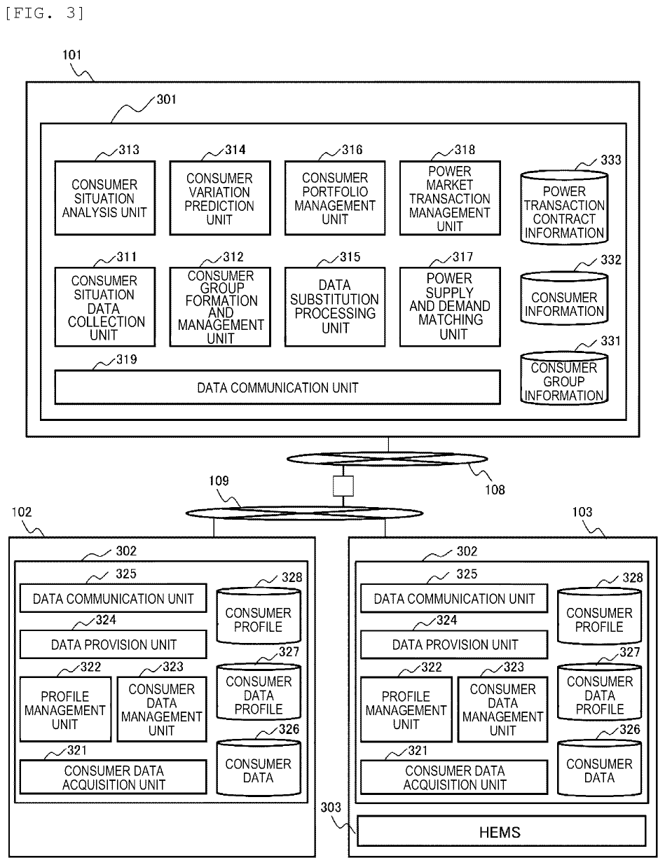

FIG. 3 is a diagram showing a module configuration of functional units of the energy platform server and the consumer server according to the present embodiment.

An energy platform middleware 301 is introduced into the energy platform server 101, and the energy platform middleware 301 executes the processing related to the power market transaction 201 of the small scale consumers and the processing related to the understanding and prediction of the situation related to the power supply and demand of the consumers for the contract monitoring, and manages the consumer data.

Main components of the energy platform middleware 301 include: a consumer situation data collection unit 311 that collects consumer situation data transmitted from each of the consumers; a consumer group formation and management unit 312 that executes processing related to formation and management of a consumer group and manages consumer group information table 331 and consumer information table 332; a consumer situation analysis unit 313 that analyzes a situation related to current power supply and demand of the consumers based on the consumer situation data; a consumer variation prediction unit 314 that executes, based on the consumer situation data and the like, processing related to the variation of the power supply and demand and the prediction of the situation until the power transfer time is reached and processing related to prediction result substitution in the consumer group; a data substitution processing unit 315 that executes processing related to data substitution in the consumer group; a consumer portfolio management unit 316 that manages a portfolio of the power transaction based on a contract; a power supply and demand matching unit 317 that executes processing related to the power supply and demand matching for the power transaction; a power market transaction management unit 318 that manages the power market transaction of the consumers and manages power transaction contract information 333; and a data communication unit 319 that communicates with the consumer servers (102, 103, 104, 105) or the AEMS servers (106, 107) via the network 108 and the networks (109, 110).

For example, in the preliminary phase shown in FIG. 2, the consumer portfolio management unit 316 performs processing related to contract reception and the portfolio consignment setting shown in FIG. 2, the power market transaction management unit 318 performs the proxy processing of bidding, and the power supply and demand matching unit 317 performs the processing related to the supply and demand matching. In addition, for example, in the preliminary phase, the consumer situation analysis unit 313 performs the processing related to the contract monitoring, and the consumer variation prediction unit 314 performs the processing related to the prediction of the situation related to the power supply and demand of the consumers. Further, in the post phase shown in FIG. 2, the consumer portfolio management unit 316 performs processing related to the evaluation on the record of the power transaction and the bid order setting change.

A consumer data management middleware 302 that executes processing related to acquisition and management of the consumer data and transmission of the consumer data to the energy platform server 101 is introduced into each of the consumer server (102, 103, 104, 105). In addition, a HEMS 303 that manages the consumer facilities is introduced into each of the consumer servers (102, 103, 104, 105). The HEMS is generally a management system for saving energy (for example, power energy) consumed by a consumer and appropriately controlling facilities of the consumer. Although the HEMS is exemplified in the present embodiment, the invention may be similarly applied to other systems having similar functions.

Main components of the consumer data management middleware 302 include: a consumer data acquisition unit 321 that acquires smart meter data, various types of IoT sensor data, or data managed by the HEMS in the consumer home; a profile management unit 322 that manages a consumer data profile 327 and a consumer profile 328; a consumer data management unit 323 that stores the acquired consumer data and manages consumer data 326; a data provision unit 324 that executes processing related to provision of the consumer data to the energy platform server 101; and a data communication unit 325 that communicates with the energy platform server 101 or the AEMS servers (106, 107) via the network 108 and the networks (109, 110).

For example, in the preliminary phase and the post phase shown in FIG. 2, the profile management unit 322 performs the contract processing, and the data provision unit 324 performs the situation notification related to the power supply and demand.

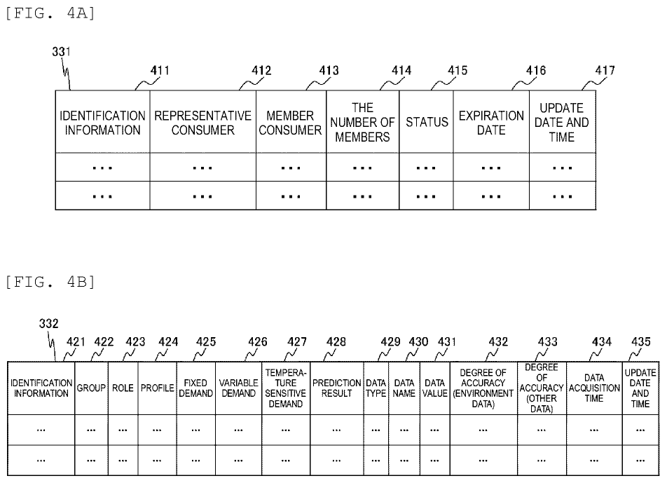

FIGS. 4A and 4B are diagrams showing configurations of tables used in the data substitution system according to the present embodiment.

Main components include a consumer group information table 331 (FIG. 4A) that stores information related to the consumer group and a consumer information table 332 (FIG. 4B) that stores information related to the consumer, which are managed by the energy platform server 101.

Main components of the consumer group information table 331 include identification information 411, a representative consumer 412, a member consumer 413, the number of members 414, a status 415, an expiration date 416, and an update date and time 417.

Information for identifying the consumer group is stored in the identification information 411. Information related to a representative consumer of the consumer group specified by the identification information 411 is stored in the representative consumer 412. Information related to one or more consumers who are members of the consumer group specified by the identification information 411 is stored in the member consumer 413. Information related to the number of member consumers of the consumer group specified by the identification information 411 is stored in the number of members 414. Information related to a status of the consumer group specified by the identification information 411 is stored in the status 415. The status of the consumer group is information, such as “under initial construction”, “in operation”, and “suspended”, related to an operation state of the consumer group specified by the identification information 411. Information related to an expiration date of the consumer group specified by the identification information 411 is stored in the expiration date 416. A date and time when the records 411 to 416 are updated last is stored in the update date and time 417.

Main components of the consumer information table 332 include identification information 421, a group 422, a role 423, a profile 424, fixed demand 425, variable demand 426, temperature sensitive demand 427, a prediction result 428, a data type 429, a data name 430, a data value 431, a degree of accuracy (environment data) 432, a degree of accuracy (other data) 433, a data acquisition time 434, and an update date and time 435.

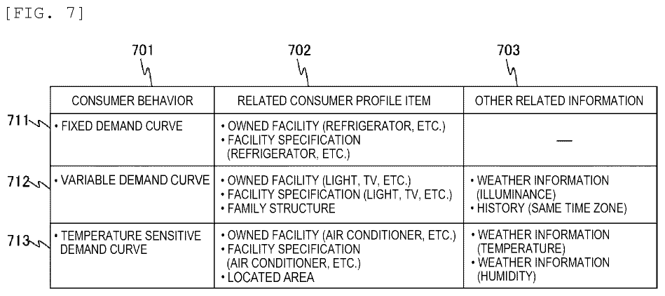

Information for identifying a consumer is stored in the identification information 421. Information related to a consumer group to which the consumer specified by the identification information 421 belongs is stored in the group 422. Information related to a role of the consumer specified by the identification information 421 in the consumer group specified by the group 422 is stored in the role 423. The role is, for example, “representative” or “member”. Information related to a profile of the consumer specified by the identification information 421 or pointer information to the information (for example, FIG. 7) is stored in the profile 424. Information related to fixed demand of the consumer specified by the identification information 421 or pointer information to the information is stored in the fixed demand 425. Information related to variable demand of the consumer specified by the identification information 421 or pointer information to the information is stored in the variable demand 426. Information related to temperature sensitive demand of the consumer specified by the identification information 421 or pointer information to the information is stored in the temperature sensitive demand 427.

Information related to a prediction result of the consumer specified by the identification information 421 is stored in the prediction result 428. When the consumer specified by the identification information 421 is a member of the consumer group specified by the group 422, prediction result information of a representative consumer of the consumer group is stored as a substitute. Information related to a data type of data of the consumer specified by the identification information 421 or pointer information to the information is stored in the data type 429. As the data type, for example, “environment data”, “human and action data”, “facility data”, and “power data” are set. Information related to a name of the data of the consumer specified by the identification information 421 or pointer information to the information is stored in the data name 430. Information related to a value of data of the consumer specified by the identification information 421 or pointer information to the information is stored in the data value 431.

More specifically, in the data type, the “environment data” is set when information indicating an environment (for example, weather information such as a temperature, a humidity, and a precipitation amount) is included in data that is a source for identifying the data type 429. In addition, when information indicating an action of the consumer (for example, a movement history of a smartphone registered as the action of the consumer) is included in the data that is a source for identifying the data type 429, the “human and action data” is set. In addition, when information indicating a facility of the consumer (for example, information related to the HEMS registered as the facility of the consumer) is included in the data that is a source for identifying the data type 429, the “facility data” is set. In addition, when information indicating power transfer of the consumer (for example, information related to a power consumption amount of the consumer) is included in the data that is a source for identifying the data type 429, the “facility data” is set.

When the consumer specified by the identification information 421 is a member of the consumer group specified by the group 422, information related to data of the representative consumer of the consumer group is stored in the data type 429, the data name 430, and the data value 431 as a substitute. In addition, as described above, the data value 431 includes data (for example, “° C.” which is a unit of temperature when information indicating a temperature is included in the data value 431) that is a source for identifying the data type 429, an actual measurement value (for example, a value “30” of 30° C.) represented by the source data, and an acquisition time (for example, 2021/03/31 12:00:00) which is a time when the data is measured.

When the “environment data” is included in the information stored in the data type 429, information related to the degree of accuracy of the environment data stored in the data value 431 or pointer information to the information is stored in the degree of accuracy (environment data) 432. When the “human and action data”, the “facility data”, and the “power data” are included in the information stored in the data type 429, information related to the degrees of accuracy of the human and action data, the facility data, and the power data stored in the data value 431 or pointer information to the information is stored in the degree of accuracy (other data) 433. A date and time when the information stored in the data type 429, the data name 430, and the data value 431 is acquired from the consumer is stored in the data acquisition time 434. A date and time when the records 421 to 434 are updated last is stored in the update date and time 435.

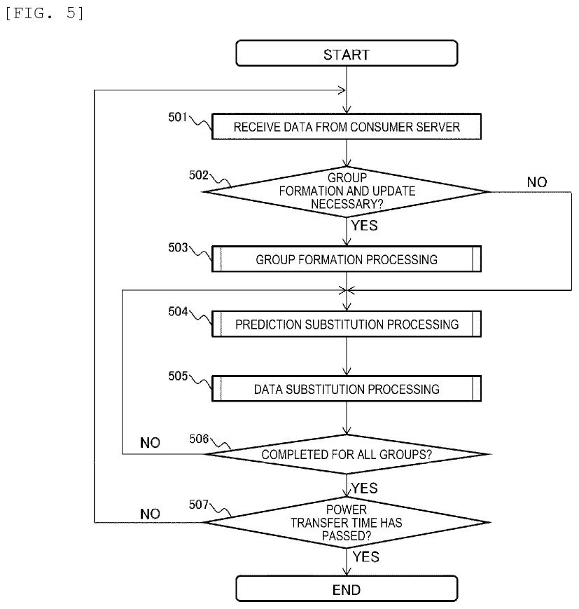

FIG. 5 is a flowchart showing a flow of processing for executing formation of a consumer group, prediction substitution, and data substitution based on a degree of coincidence in a consumer profile and a behavior in the data substitution system according to the present embodiment. The following processing is periodically performed at a certain timing (for example, 8 a.m. once a day).

In 501, the energy platform server 101 receives the consumer data 326 transmitted from each of the consumer servers (102, 103, 104, 105) of the respective consumers at a constant frequency.

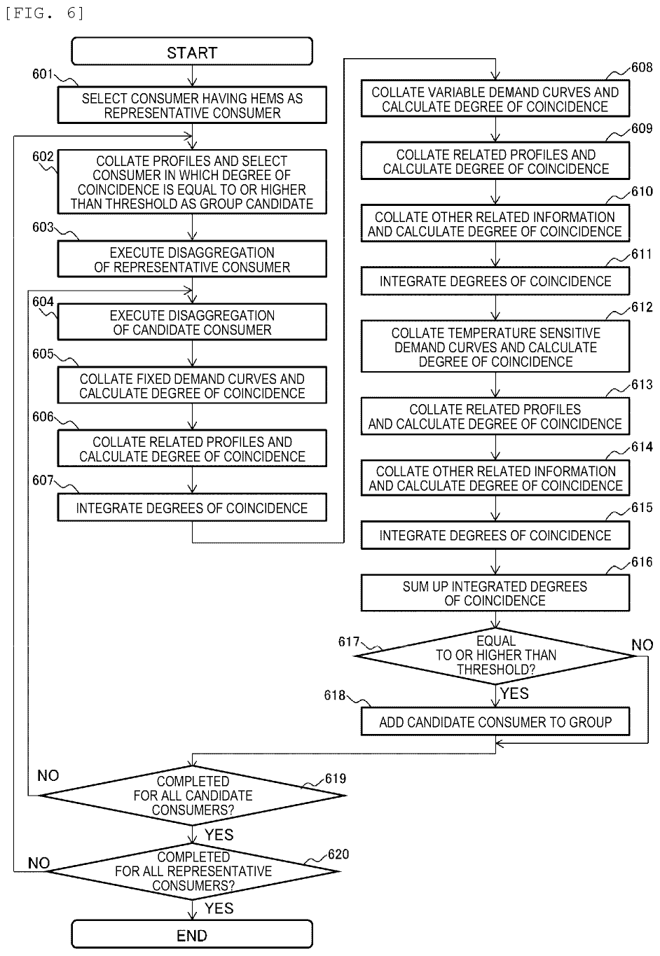

In 502, when the energy platform server 101 determines that it is necessary to newly form or update the group (502; YES), in 503, the energy platform server 101 executes group formation processing. Details of the group formation processing are shown in FIG. 6. For example, when the status 415 is “under initial construction” or when the identification information 421 of the new consumer information table 332 is added (that is, when a new consumer is added as a member of the consumer group), the group formation processing is performed.

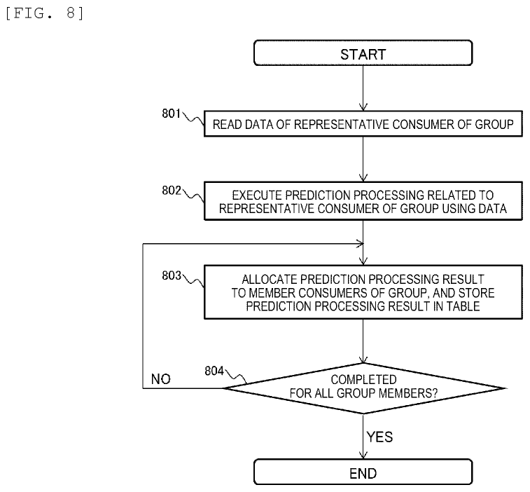

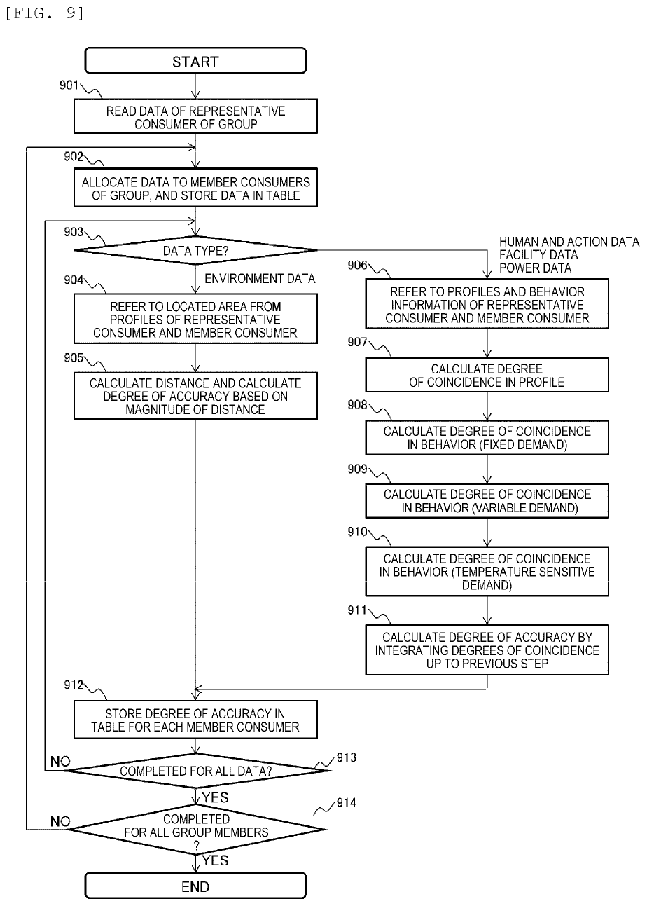

In 502, when the energy platform server 101 determines that it is not necessary to newly form or update the group (502; NO), the energy platform server 101 executes the processing in and after 504. The energy platform server 101 executes prediction substitution processing in 504. Details of the prediction substitution processing are shown in FIG. 8. The energy platform server 101 executes data substitution processing in 505. Details of the data substitution processing are shown in FIG. 9.

When it is determined in 506 that the execution is not completed for all the groups (506; NO), the energy platform server 101 repeats the processing of 504 and 505. When the energy platform server 101 determines that the execution is completed for all the groups (506; YES) in 506, the energy platform server 101 determines whether a power transfer execution time has passed in 507. When it is determined that the power transfer execution time has not passed (507; NO), the energy platform server 101 repeats the processing of 501 to 506. When the power transfer execution time has passed (507; YES), the energy platform server 101 ends the processing in 507. The case where the power transfer execution time has passed is, for example, a case where a time of “power transfer” of the day shown in FIG. 2 has passed.

The group is not newly formed every time the data is received from the consumer, and is maintained for a certain period of time. In addition, when a predetermined condition is satisfied (for example, a certain period of time has elapsed after formation, a time zone is changed, and the number of members who are joining or operating is reduced), update or deletion is performed.

FIG. 6 is a flowchart showing a flow of processing for calculating the degree of coincidence in the consumer profile and the behavior and forming the consumer group in the data substitution system according to the present embodiment.

In 601, the energy platform server 101 selects, from the consumers (102, 103, 104, 105) managed by the energy platform server 101, one or more consumers having a home energy management system (HEMS) as representative consumers. Whether the consumer is a consumer having the HEMS is, for example, to determine whether the HEMS 303 is described as a facility in the profile 424 shown in FIG. 4B, and when it is determined that the facility is described, the consumer may be selected as a representative consumer.

In 602, the energy platform server 101 collates profiles and selects, as a member candidate of the group of the representative consumer, a consumer in which a degree of coincidence with the representative consumer is equal to or higher than a predetermined threshold. For example, when contents and the number of items of a related consumer profile item 702 (to be described later) shown in FIG. 7 described as owned facilities and facility specifications are similar by a certain degree, the consumer may be selected as a member candidate.

In 603, the energy platform server 101 executes disaggregation of the smart meter data acquired from the representative consumer, and calculates a fixed demand curve, a variable demand curve, and a temperature sensitive demand curve of the representative consumer. Various techniques known in the related art may be used in a disaggregation method of the smart meter data.

In 604, the energy platform server 101 executes disaggregation of the smart meter data acquired from the member candidate consumer, and calculates a fixed demand curve, a variable demand curve, and a temperature sensitive demand curve of the member candidate consumer. As in the case of 603, various techniques known in the related art may be used in a disaggregation method of the smart meter data.

In 605, the energy platform server 101 collates the fixed demand curves of the representative consumer and the member candidate consumer calculated in 603 and 604, and calculates the degree of coincidence. Here, for example, when a degree of similarity between curves in a certain time width is equal to or higher than a certain threshold, the degree of coincidence can be calculated as that the fixed demand curves of the representative consumer and the member candidate consumer coincide with each other.

In 606, the energy platform server 101 collates, for the representative consumer and the member candidate consumer, items of the profile related to fixed demand described in FIG. 7, and calculates the degree of coincidence. For example, as will be described later, the energy platform server 101 calculates, for the related consumer profile item 702 shown in FIG. 7, a degree of coincidence in the contents and the number of items of the related consumer profile item 702 corresponding to a fixed demand curve 711 in a consumer behavior 701. More specifically, for example, the energy platform server 101 may calculate, based on a ratio at which facilities (for example, facilities such as kitchen) related to temporally fixed power demand of a consumer which occurs at the same time every day, such as a “refrigerator”, an “IH cooking heater”, and a “water heater” as owned facilities among the items included in the related consumer profile item 702 coincide, the degree of coincidence between the profile items of the representative consumer and the member candidate consumer. Here, the facilities in the kitchen or the like are exemplified, and the invention may be similarly applied for other facilities related to various types of fixed demand provided in the consumer.

In 607, the energy platform server 101 integrates the degrees of coincidence calculated in 605 and 606.

In 608, the energy platform server 101 collates the variable demand curves of the representative consumer and the member candidate consumer calculated in 603 and 604, and calculates the degree of coincidence. In the calculation of the degree of coincidence, similarly to the case of 605, when a degree of similarity between curves in a certain time width is equal to or higher than a certain threshold, the degree of coincidence may be calculated as that the variable demand curves of the representative consumer and the member candidate consumer coincide with each other.

In 609, for the representative consumer and the member candidate consumer, items of the profile related to variable demand described in FIG. 7 are collated to calculate the degree of coincidence. For example, as will be described later, the energy platform server 101 calculates, for the related consumer profile item 702 shown in FIG. 7, a degree of coincidence in the contents and the number of items of the related consumer profile item 702 corresponding to a variable demand curve 712 in the consumer behavior 701. More specifically, for example, the energy platform server 101 may calculate, based on a ratio at which facilities (for example, facilities in a living room) related to temporally varying power demand that changes according to the convenience of the consumer at each time, such as a “light”, a “TV (television)”, and a “stereo” as owned facilities among the items included in the related consumer profile item 702 coincide, the degree of coincidence between the profile items of the representative consumer and the member candidate consumer. Further, since it is considered that a use frequency of the owned facilities increases as the number of family members in the consumer increases, a degree of coincidence in a family structure (for example, a married couple) of the consumer may be calculated. Here, the facilities in the living room are exemplified, and the invention may be similarly applied to other facilities related to various types of variable demand provided in the consumer.

In 610, for the representative consumer and the member candidate consumer, items of other related information related to variable demand described in FIG. 7 are collated to calculate the degree of coincidence. For example, as will be described later, the energy platform server 101 calculates, for other related information 703 corresponding to the related consumer profile item 702 shown in FIG. 7, a degree of coincidence in the contents and the number of items of the other related information 703 corresponding to the variable demand curve 712 in the consumer behavior 701. More specifically, for example, the energy platform server 101 may calculate, based on a ratio at which “illuminance” and an environmental condition as weather information among the items included in the other related information 703 coincide, the degree of coincidence between the items of the other related information of the representative consumer and the member candidate consumer. Here, the environmental condition is exemplified, the invention may be similarly applied to various types of other related information that is based on the action and state of the consumer.

In 611, the energy platform server 101 integrates the degrees of coincidence calculated in 608 to 610.

In 612, the energy platform server 101 collates the temperature sensitive demand curves of the representative consumer and the member candidate consumer calculated in 603 and 604, and calculates the degree of coincidence. In the calculation of the degree of coincidence, similarly to the case of 605 and 608, when a degree of similarity between curves in a certain time width is equal to or higher than a certain threshold, the degree of coincidence may be calculated as that the temperature sensitive demand curves of the representative consumer and the member candidate consumer coincide with each other.

In 613, the energy platform server 101 collates, for the representative consumer and the member candidate consumer, items of the profile related to temperature sensitive demand described in FIG. 7, and calculates the degree of coincidence. For example, as will be described later, the energy platform server 101 calculates, for the related consumer profile item 702 shown in FIG. 7, a degree of coincidence in the contents and the number of items of the related consumer profile item 702 corresponding to a temperature sensitive demand curve 713 in the consumer behavior 701. More specifically, for example, the energy platform server 101 may calculate, based on a ratio at which facilities related to power demand associated with a change in temperature, such as an “air conditioner”, a “fan heater”, and a “floor heating” as owned facilities among the items included in the related consumer profile item 702 coincide, the degree of coincidence between the profile items of the representative consumer and the member candidate consumer. Here, facilities are exemplified, and the invention may be similarly applied to various types of other related information that is based on the change in temperature.

In 614, the energy platform server 101 collates, for the representative consumer and the member candidate consumer, items of other related information related to temperature sensitive demand described in FIG. 7, and calculates the degree of coincidence. For example, as will be described later, the energy platform server 101 calculates, for the other related information 703 corresponding to the related consumer profile item 702 shown in FIG. 7, a degree of coincidence in the contents and the number of items of the other related information 703 corresponding to the temperature sensitive demand curve 713 in the consumer behavior 701. More specifically, for example, the energy platform server 101 may calculate, based on a ratio at which information of a “temperature” and a “humidity” as weather information among the items included in the other related information 703 coincide, the degree of coincidence between the items of the other related information of the representative consumer and the member candidate consumer. Here, the environmental condition is exemplified, the invention may be similarly applied to various types of other related information that is based on the action and state of the consumer.

In 615, the energy platform server 101 integrates the degrees of coincidence calculated in 612 to 614.

In 616, the energy platform server 101 sums up the degrees of coincidence integrated in 606, 611, and 616.

In 617, when the energy platform server 101 determines that the degree of coincidence summed up in 616 is equal to or higher than the predetermined threshold (617; YES), the energy platform server 101 adds the member candidate consumer as a member to the group of the representative consumer in 618. In 617, when the degree of coincidence summed up in 616 is not equal to or higher than the predetermined threshold (617; NO), the energy platform server 101 executes the processing in and after 619.

In 619, when the processing is not completed for all the member candidate consumers (619; NO), the energy platform server 101 repeats the processing of 604 to 618. In 619, when the processing is completed for all the member candidate consumers (619; YES), the processing proceeds to 620.

In 620, when the processing is not completed for all the representative consumers (620; NO), the energy platform server 101 repeats the processing of 602 to 619. In 620, when the processing is completed for all the representative consumers (620; YES), the energy platform server 101 ends the processing.

FIG. 7 is a diagram showing a concept for selecting a more similar consumer in the data substitution system according to the present embodiment. FIG. 7 shows an example of the profile 424 shown in FIG. 4B. The processing of 605 to 615 in FIG. 6 is based on the method.

In order to select a more similar consumer, the energy platform server 101 selects a consumer in which a degree of coincidence is high in all of the consumer behavior 701 indicating the behavior of the consumer, the related consumer profile item 702 which is an item having a deep relationship with the behavior, and the other related information 703 about the consumer.

For example, a case where the consumer behavior 701 is the fixed demand curve 711 is considered. Since the fixed demand is temporally fixed demand, which occurs at the same time every day, such as a refrigerator, in the related consumer profile item 702, the presence or absence of a refrigerator and the like is particularly exemplified as the owned facility, and the specification of the refrigerator and the like (for example, a size of a capacity of a chiller or a freezing chamber) is exemplified.

In addition, for example, when the consumer behavior 701 is the variable demand curve 712, since the variable demand is temporally varying demand that changes according to the convenience of the consumer at each time, such as a “light”, in the related consumer profile item 702, the presence or absence of a light, a TV, and the like are particularly exemplified as the owned facilities, and the specifications of the light, the TV, and the like are exemplified. In addition, the other related information 703 is weather information such as illuminance or history information in the same time zone. The history information in the same time zone is, for example, a use history of facilities in the same time zone, such as one hour from 17:00 to 18:00, when viewed in a period of one week.

When the consumer behavior 701 is the temperature sensitive demand curve 713, since the temperature sensitive demand is a demand associated with a change in temperature, in the related consumer profile item 702, the presence or absence of an air conditioner and the like is particularly exemplified as the owned facility, the specification of the air conditioner and the like, and located area information of the consumer are exemplified. In addition, weather information such as a temperature and a humidity is exemplified as the other related information 703 having deep relation.

FIG. 8 is a flowchart showing a flow of processing for executing the prediction substitution in the formed consumer group in the data substitution system according to the present embodiment.

In 801, the energy platform server 101 reads the consumer data 326 collected from the consumer server of the representative consumer of the group.

In 802, the energy platform server 101 executes prediction processing related to the representative consumer of the group using the data. Here, the prediction processing is executed using an appropriate prediction algorithm known in the related art according to a purpose. In addition, the prediction processing is, for example, “prediction” in the preliminary phase shown in FIG. 2.

In 803, the energy platform server 101 allocates the prediction processing results to the respective member consumers of the group, and stores the prediction processing results in the corresponding areas of the respective consumers in the table. For example, when prediction of using 100 KW is acquired, using a predetermined prediction algorithm, as a situation related to power supply and demand to be used by a certain consumer in 802, the energy platform server 101 records the value in the prediction result 428 of the consumer information table 332 (FIG. 4B) of each of the consumers.

In 804, when it is determined that the execution is not completed for all the member consumers of the group formed in 503 (804; NO), the energy platform server 101 repeats the processing of 803. In 804, when it is determined that the execution is completed for all the member consumers of the group (804; YES), the processing is ended.

FIG. 9 is a flowchart showing a flow of processing for executing the data substitution in the formed consumer group and calculating a degree of accuracy of the substitution data in the data substitution system according to the present embodiment. Here, the degree of accuracy is defined as a degree of deviation from data that is originally present. For example, it is defined that the smaller the deviation between the data that is originally present as the consumer data before the substitution and the consumer data after the substitution, the higher the degree of accuracy is.

In 901, the energy platform server 101 reads the consumer data 326 collected from the consumer server of the representative consumer of the group.

In 902, the energy platform server 101 allocates the consumer data 326 to respective items of the consumer data 326 of each of the member consumers of the group, and stores the consumer data 326 in the corresponding areas of each of the consumers in the table.

In 903, the energy platform server 101 determines whether a data type of the allocated data is the “environment data”.

When it is determined that the type of the allocated data is the “environment data” in 903, the energy platform server 101 refers to the located area information indicating an address of the consumer or a location of the consumer server from the profiles of the representative consumer and the member consumer in 904. For example, the energy platform server 101 refers to a located area included in the profile 424 when the data type 429 in the consumer information table shown in FIG. 4B is the “environment data”.

In 905, the energy platform server 101 calculates a distance between the representative consumer and the member consumer based on the located area information of the representative consumer and the member consumer referred to in 904, and calculates the degree of accuracy based on a magnitude of the distance (the smaller the distance, the higher the degree of accuracy is set).

When it is determined that the types of the allocated data are the “human and action data”, the “facility data”, and the “power data” in 903, the energy platform server 101 refers to the profiles and behavior information of the representative consumer and the member consumer in 906. For example, the energy platform server 101 refers to the profile 424, and the fixed demand 425, the variable demand 426, and the temperature sensitive demand 427 as the behavior information in the consumer information table shown in FIG. 4B.

In 907, the energy platform server 101 calculates the degree of coincidence between the profile information of the representative consumer and the member consumer referred to in 906. The calculation of the degree of coincidence may be performed, for example, in the same manner as the processing performed in 606, 609, and 613 in FIG. 6.

In 908, the energy platform server 101 calculates the degree of coincidence in the fixed demand curve among the behavior information of the representative consumer and the member consumer referred to in 906. The calculation of the degree of coincidence may be performed, for example, in the same manner as the processing performed in 605 in FIG. 6.

In 909, the energy platform server 101 calculates the degree of coincidence in the variable demand curve among the behavior information of the representative consumer and the member consumer referred to in 906. The calculation of the degree of coincidence may be performed, for example, in the same manner as the processing performed in 608 in FIG. 6.

In 910, the energy platform server 101 calculates the degree of coincidence in the temperature sensitive demand curve among the behavior information of the representative consumer and the member consumer referred to in 906. The calculation of the degree of coincidence may be performed, for example, in the same manner as the processing performed in 612 in FIG. 6.

In 911, the energy platform server 101 calculates the degree of accuracy by integrating the degrees of coincidence calculated in 907 to 910.

In 912, the energy platform server 101 stores the degree of accuracy calculated in 905 or 911 into the degree of accuracy (environment data) 432 and the degree of accuracy (other data) 433 which are corresponding areas in the table of the member consumer.

In 913, when it is determined that the processing is not completed for all the data allocated to the member consumer (913; NO), the energy platform server 101 repeats the processing of 903 to 912. In 913, the energy platform server 101 determines whether the processing is completed for all the data allocated to the member consumer.

When it is determined in 913 that the processing is completed for all the data allocated to the member consumer (913; YES), the energy platform server 101 determines in 914 whether the processing is completed for all the member consumers of the group. When it is determined that the processing is not completed for all the member consumers of the group (914; NO), the energy platform server 101 repeats the processing of 902 to 913.

When it is determined in 914 that the processing is completed for all the member consumers of the group (914; YES), the energy platform server 101 ends the processing.

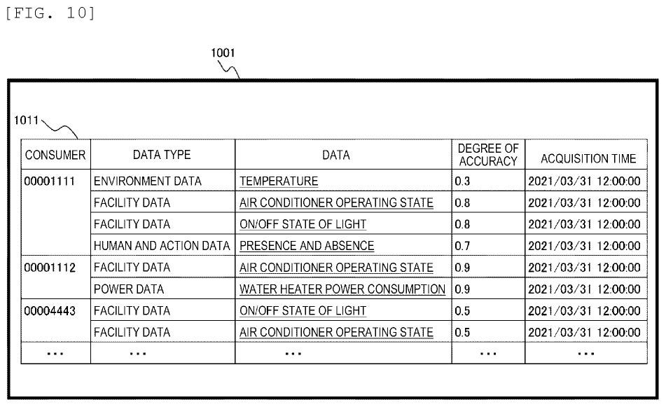

FIG. 10 is a diagram showing an image of a screen for presenting, to a user, the substitution data provided in the data substitution system according to the present embodiment.

On a screen 1001, for example, information related to the substituted data type, data, degree of accuracy, acquisition time, and the like for each consumer is displayed in a table format list 1011. For example, in FIG. 10, for the consumer identified by the identification information 421, the data value 431 of the data related to the “temperature” of the data name 430 classified as the “environment data” represented by the data type 429 is substituted, and the degree of accuracy 432 is “0.3”. In addition, the acquisition time 434 of the data is “2021/03/31 12:00:00”. The data substitution processing unit 315 outputs the screen to a display device such as a display connected to the system.

When there is no corresponding information, a blank portion is displayed. Regarding each item of the table format list 1011, for example, the identification information 421 in the consumer information table shown in FIG. 4B may be read and displayed for a “consumer” item, the data type 429, the data name 430, and the data value 431 may be read and displayed for “data type” and “data” items, and the data acquisition time 434 may be read and displayed for an “acquisition time” item.

As described above, in the present embodiment, a data substitution system (for example, the energy platform server 101) in a power service system (for example, the power service system 1000) for transmitting and receiving, by a computer, data related to power transfer with a plurality of consumers in a preliminary phase (for example, the “preliminary” shown in FIG. 2) in which a power supply and demand situation is monitored to perform power supply and demand prediction for the power transfer with the plurality of consumers and in a post phase (for example, the “post” shown in FIG. 2) in which a consumed power supply and demand record is monitored based on the power transfer. The data substitution system includes: a communication unit (for example, the data communication unit 319) configured to receive the data related to the power transfer from a consumer server (for example, the consumer servers 102, 103, 104, and 105) provided in each of the plurality of consumers; a group formation processing unit (for example, the consumer group formation and management unit 312) configured to select, when a predetermined facility related to the power transfer is included in profile information (for example, the profile 424 and the related consumer profile item 702) of a consumer included in the received data (for example, the consumer group information table 331 and the consumer information table 332) related to the power transfer, the consumer as a representative consumer, select, as a member consumer, a consumer in which a degree of coincidence with the profile information of the selected representative consumer and with behavior information (for example, the fixed demand 425, the variable demand 426, the temperature sensitive demand 427, and the consumer behavior 701) which is related to power supply and demand of the representative consumer and which is associated with the data related to the power transfer is equal to or higher than a predetermined threshold, and form the selected representative consumer and member consumer as one group; a prediction substitution processing unit (for example, the data substitution processing unit 315) configured to predict a situation related to the power supply and demand using a predetermined prediction algorithm for the selected representative consumer in the formed group and set a result of the prediction as a prediction result for the member consumer; and a data substitution processing unit (for example, the data substitution processing unit 315) configured to substitute the result of the prediction as a prediction result for a member consumer included in the group, the units being executed by the computer (for example, the energy platform server 101). Accordingly, it is possible to acquire data for which a service is requested without increasing a load of processing related to situation understanding and prediction accompanying an increase in the number of target consumers.

For example, in order to reduce the load of the processing related to situation understanding and prediction of a large number of target consumers, one or more consumers in each of which profile information and behavior are similar are selected in real time to form a group, and a processing result and collected data are substituted in the group, so that it is possible to complete the monitoring and adjustment until a power transfer execution time without delay. As a result, power market transaction and power transfer based on a contract result for a large number of small scale target consumers can be executed without delay regardless of the number of consumers and the variation on the consumer side. In addition, it is possible to collect data necessary for evaluation of the consumers and other power services without being aware of differences in the held data and situation for each consumer.

In addition, the group formation processing unit is configured to, when a HEMS is included as the predetermined facility related to the power transfer, set a consumer whose profile information includes the HEMS as the representative consumer. Accordingly, the consumer having the HEMS can be selected as the representative consumer.

In addition, the group formation processing unit is configured to select, as the member consumer, a consumer in which a degree of coincidence in the behavior information including fixed demand information (for example, the fixed demand curve 711) indicating temporally fixed power demand which occurs at the same time every day, variable demand information (for example, the variable demand curve 712) indicating temporally varying power demand that changes according to the convenience of the consumer at each time, and temperature variation demand information (for example, the temperature sensitive demand curve 713) indicating power demand associated with a change in temperature is equal to or higher than the predetermined threshold, the fixed demand information, the variable demand information, and the temperature variation demand information being acquired by disaggregating the data related to the power transfer. Accordingly, the member consumer can be selected in consideration of various types of consumer behaviors such as fixed demand, variable demand, and temperature sensitive demand.

In addition, the group formation processing unit is configured to select the member consumer which is a candidate of the group based on the degree of coincidence in the profile information including an owned facility (for example, the refrigerator) of the consumer, a facility specification (for example, the size of the capacity of the chiller or the freezing chamber of the refrigerator) of the facility, a family structure (for example, a married couple) of the consumer, and a located area of the consumer (for example, the address of the consumer or the installation location of the consumer server), and disaggregate the data related to the power transfer of the member consumer which is the selected candidate of the group. Accordingly, it is possible to select the member consumer in consideration of contents of the detailed profile including a surrounding environment of the consumer, and then perform the disaggregation.

In addition, the group formation processing unit is configured to select, as the member consumer, a consumer in which the degree of coincidence in the behavior information including a related consumer profile item (for example, the “refrigerator” as the owned facility) corresponding to the fixed demand information, a related consumer profile item (for example, the “light” and the “TV” as the owned facilities) and other related information (for example, the “illuminance” as the weather information) corresponding to the variable demand information, and a related consumer profile item (for example, the “air conditioner”, the “fan heater”, and the “floor heating” as the owned facilities) and other related information (for example, the “temperature” as the weather information) corresponding to the temperature variation demand information is equal to or higher than the predetermined threshold. Accordingly, it is possible to select the consumer in consideration of various consumer profile items and other related information of the consumer.

In addition, the data substitution processing unit is configured to calculate a degree of accuracy (for example, the degree of accuracy (environment data) 432 and the degree of accuracy (other data) 433) indicating a degree of deviation between the data related to the power transfer of the member consumer for which the prediction result is substituted and data that is originally present as the data related to the power transfer of the member consumer. Accordingly, it is possible to understand the degree of deviation from the originally present data of the member consumer whose data is substituted by that of the representative consumer.

In addition, the data substitution processing unit is configured to, when a data type included in the data related to the power transfer of the representative consumer and the data related to the power transfer of the consumer is a type indicating information related to an environment (for example, the “environment data” represented by the data type 429), calculate the degree of accuracy based on magnitude of a distance between located area information, which indicates an address of the representative consumer or a location of the consumer server, included in the profile information of the representative consumer and that included in the profile information of the member consumer. Accordingly, it is possible to calculate the degree of accuracy in consideration of residential areas or installation locations of the representative consumer and the member consumer.

In addition, the data substitution processing unit is configured to, when a data type included in the data related to the power transfer of the representative consumer and the data related to the power transfer of the consumer is a type indicating any one of information indicating an action of the consumer (for example, the “human and action data” represented by the data type 429), information indicating a facility of the consumer (for example, the “facility data” represented by the data type 429), and information indicating power transfer of the consumer (for example, the “power data” represented by the data type 429), calculate the degree of coincidence in the profile information between the representative consumer and the member consumer and the degree of coincidence between the behavior information related to the power supply and demand of the representative consumer and the behavior information related to the power supply and demand of the member consumer. Accordingly, it is possible to calculate the degree of accuracy in consideration of the action of the consumer, the facilities held by the consumer, and the power transfer situation of the consumer.

In addition, the data substitution processing unit is configured to display, for the member consumer for which the prediction result is substituted, information related to the substituted data related to the power transfer and the degree of accuracy on a display device (for example, the display device such as a display connected to the system as shown in FIG. 10). Accordingly, an administrator of the system can understand at a glance a degree of deviation from the originally present data of any data type for each member consumer.

### REFERENCE SIGNS LIST

1000: power service system
101: energy platform server
102, 103, 104, 105: consumer server
105, 107: AEMS server
108, 109, 110: network

1. A data substitution system in a power service system for transmitting and receiving, by a computer, data related to power transfer with a plurality of consumers in a preliminary phase in which a power supply and demand situation is monitored to perform power supply and demand prediction for the power transfer with the plurality of consumers and in a post phase in which a consumed power supply and demand record is monitored based on the power transfer, the data substitution system comprising:
a communication unit configured to receive the data related to the power transfer from a consumer server provided in each of the plurality of consumers;
a group formation processing unit configured to select, when a predetermined facility related to the power transfer is included in profile information of a consumer included in the received data related to the power transfer, the consumer as a representative consumer, select, as a member consumer, a consumer in which a degree of coincidence with the profile information of the selected representative consumer and with behavior information which is related to power supply and demand of the representative consumer and which is associated with the data related to the power transfer is equal to or higher than a predetermined threshold, and form the selected representative consumer and member consumer as one group;
a prediction substitution processing unit configured to predict a situation related to the power supply and demand using a predetermined prediction algorithm for the selected representative consumer in the formed group and set a result of the prediction as a prediction result for the member consumer; and
a data substitution processing unit configured to substitute the result of the prediction as a prediction result for a member consumer included in the group,
the units being implemented by the computer.

2. The data substitution system according to claim 1, wherein
the group formation processing unit is configured to, when a HEMS is included as the predetermined facility related to the power transfer, set a consumer whose profile information includes the HEMS as the representative consumer.

3. The data substitution system according to claim 1, wherein
the group formation processing unit is configured to select, as the member consumer, a consumer in which a degree of coincidence in the behavior information including fixed demand information indicating temporally fixed power demand, variable demand information indicating temporally varying power demand, and temperature variation demand information indicating power demand associated with a change in temperature is equal to or higher than the predetermined threshold, the fixed demand information, the variable demand information, and the temperature variation demand information being acquired by disaggregating the data related to the power transfer.

4. The data substitution system according to claim 3, wherein
the group formation processing unit is configured to select the member consumer which is a candidate of the group based on the degree of coincidence in the profile information including an owned facility of the consumer, a facility specification of the facility, a family structure of the consumer, and a located area of the consumer, and disaggregate the data related to the power transfer of the member consumer which is the selected candidate of the group.

5. The data substitution system according to claim 3, wherein
the group formation processing unit is configured to select, as the member consumer, a consumer in which the degree of coincidence in the behavior information including a profile item of the consumer corresponding to the fixed demand information, a profile item of the consumer and other related information corresponding to the variable demand information, and a profile item of the consumer and other related information corresponding to the temperature variation demand information is equal to or higher than the predetermined threshold.

6. The data substitution system according to claim 1, wherein
the data substitution processing unit is configured to calculate a degree of accuracy indicating a degree of deviation between the data related to the power transfer of the member consumer for which the prediction result is substituted and data that is originally present as the data related to the power transfer of the consumer member.

7. The data substitution system according to claim 6, wherein
the data substitution processing unit is configured to, when a data type included in the data related to the power transfer of the representative consumer and the data related to the power transfer of the consumer is a type indicating information related to an environment, calculate the degree of accuracy based on magnitude of a distance between located area information, which indicates an address of the representative consumer or a location of the consumer server, included in the profile information of the representative consumer and that included in the profile information of the member consumer.

8. The data substitution system according to claim 6, wherein
the data substitution processing unit is configured to, when a data type included in the data related to the power transfer of the representative consumer and the data related to the power transfer of the consumer is a type indicating any one of information indicating an action of the consumer, information indicating a facility of the consumer, and information indicating power transfer of the consumer, calculate the degree of coincidence in the profile information between the representative consumer and the member consumer and the degree of coincidence between the behavior information related to the power supply and demand of the representative consumer and the behavior information related to the power supply and demand of the member consumer.

9. The data substitution system according to claim 6, wherein
the data substitution processing unit is configured to display, for the member consumer for which the prediction result is substituted, information related to the substituted data related to the power transfer and the degree of accuracy on a display device.

10. A data substitution method to be performed in a power service system for transmitting and receiving, by a computer, data related to power transfer with a plurality of consumers in a preliminary phase in which a power supply and demand situation is monitored to perform power supply and demand prediction for the power transfer with the plurality of consumers and in a post phase in which a consumed power supply and demand record is monitored based on the power transfer, the data substitution method comprising:
a communication unit of the computer receiving the data related to the power transfer from a consumer server provided in each of the plurality of consumers;
a group formation processing unit of the computer selecting, when a predetermined facility related to the power transfer is included in profile information of a consumer included in the received data related to the power transfer, the consumer as a representative consumer, selecting, as a member consumer, a consumer in which a degree of coincidence with the profile information of the selected representative consumer and with behavior information which is related to power supply and demand of the representative consumer and which is associated with the data related to the power transfer is equal to or higher than a predetermined threshold, and forming the selected representative consumer and member consumer as one group;
a prediction substitution processing unit of the computer predicting a situation related to the power supply and demand using a predetermined prediction algorithm for the selected representative consumer in the formed group and setting a result of the prediction as a prediction result for the member consumer; and
a data substitution processing unit of the computer substituting the result of the prediction as a prediction result for a member consumer included in the group.
